(19) United States
(12) Patent Application Publication
(10) Pub. No.: US 2006/0292343 A1
(43) Pub. Date: Dec. 28, 2006

(54) MULTI-PURPOSE NON-SKID MAT

(76) Inventor: Jenna Sellers, Delray Beach, FL (US)

Correspondence Address: MALIN HALEY AND DIMAGGIO, PA, 1936 S ANDREWS AVENUE, FORT LAUDERDALE, FL, 33316, US

(21) Appl. No.: 11/160,535

(22) Filed: Jun. 28, 2005

(51) Int. Cl. B32B 3/10

(52) U.S. Cl. 428/131

(57) ABSTRACT

A multi-purpose, non-skid mat that comprises a single, flexible, thin body of elastomer material to prevent skidding, sliding, and slipping of objects or individuals on smooth, slippery, and wet surfaces. The body of elastomer material of the non-skid mat further comprises numerous parallel rows of elastomer disks interconnected at 90 degree angles by strips of elastomer material. The mat may be cut or manually torn linearly along a row or column of connecting strips to reduce the mat to a shape and size desired by the user. The mat also acts to cushion dishes and breakable cookware on hard surfaces so as to prevent damage to or breakage of the dishes against the hard surface.

### FIELD OF THE INVENTION

This invention relates to a multi-purpose, non-skid mat easily cut to a desired size for placement on countertops and other surfaces to prevent an object, such as a cutting board or mixing bowl, from sliding and for use as a cushion for dishes placed upon the mat.

### DESCRIPTION OF RELATED ART

Countertops are often slippery due to the smoothness of the planar surface of the countertop as well as the nature of the material from which said countertop is constructed. Countertops also frequently become slippery when wet. Cutting boards and other kitchen utensils placed on a wet countertop often skid and move uncontrollably. Conventional sheets of a solid non-skid material come in standards sizes with no opportunity to have a customized sheet of non-skid material. Conventional non-skid mats have been constructed typically of permeable materials, such as foam, making them unsafe for use around foods.

U.S. Pat. No. 4,137,356, issued to Shoemaker et al., on Jan. 30, 1979, describes a non-skid place mat comprising a planar base member, such as a paper or plastic sheet, and a plurality of spaced apart projections constructed from a high friction material to reduce skidding. The '356 invention differs from the applicant's invention in that the '356 patent does not describe the use of cylindrical disks interconnected by elastomer strips, nor does said patent describe the use of numerous apertures formed in a matrix between elastomer disks for draining water through the mat.

U.S. Pat. No. 5,815,856, issued to Dore on Oct. 6, 1998, describes a protective mat for sinks and countertops comprising a soft pliable mat having a central rectangular base for covering the bottom of a sink as well as four rectangular flaps to cover the sides of the sink and surrounding countertops during use of said sink. The '856 invention includes fasteners and a drain port, which are not included in the applicant's invention. Moreover, the applicant's invention includes cylindrical disks interconnected by elastomer strips surrounding numerous apertures, whereas the '856 invention is a planar cross-shaped mat having apertures only in the drain port region.

U.S. Pat. No. 6,610,382, issued to Kobe et al., on Aug. 26, 2003, describes a friction control article for wet and dry applications that comprises a backing layer with a first surface having 100 upstanding stems per square inch and a second layer. Although elastomer materials are used to construct the '382 invention, the '382 invention differs from the applicant's invention in that the design of the '382 patent renders that invention more expensive to manufacture due to the multiple layers and closely-spaced stems required by the '382 patent.

### SUMMARY OF THE INVENTION

A multi-purpose, non-skid mat comprising a single, flexible flat body of elastomer material for placement on countertops, tables and other surfaces to prevent skidding and sliding of cutting boards, mixing bowls and other kitchen utensils when in use. The non-skid mat also acts as a cushion to prevent damage to said dishes and cookware by contact with hard surfaces. The present invention is constructed of thermoplastic elastomer that is not permeable making the mat safe for use around foods. Prior art permeable mats are not safe for use around foods. The mat body is a molded elastomer material having numerous parallel rows of thin elastomer disks interconnected at 90-degree angles by four strips of elastomer material. Each elastomer disk is thicker than the four connecting strips of elastomer material, thereby creating an upper surface of said mat wherein the tops of said disks rise above the strips of elastomer connecting material which remain flush with the bottom surface of the disks on said mat. Each disk has a diameter of 0.5 inches. The distance between the centers of adjacent disks is approximately 0.625 inches. Each connection strip is 0.125 inches long. The thickness of each disk is 0.125 inches. The rows and columns of 0.125-inch strips provide easy alignment for cutting a custom-sized mat. A smaller rectangular or square mat can be quickly made with scissors or even torn by hand. The original mat size can be varied, but typically is 20 inches by 15 inches. Thus, when placed on a countertop, both the bottom surface of said elastomer disks and the bottom surface of the strips of elastomer material are coplanar and contact the planar surface of said countertop.

The flexibility of the mat allows said mat to fit within and conform to the shape of the surface on which said mat is placed. The mat can be cut to a size desired by the user so as to conform to the size required by the user by cutting through the linearly-arranged, thin elastomer strips. The linear arrangement of the elastomer disks and interconnecting elastomer strips allows the mat to be cut and reduced to a smaller size as required by the user while preserving the aesthetic appeal of said mat.

The non-skid property of the construction material not only prevents damage and breakage of dishes and cookware, but also prevents accidents, in which a cutting board may slide while the user is using a knife to cut a food material or package on said cutting board. The circular flat disks create a large surface area for a large coefficient of friction. Friction is the force that resists relative motion between two bodies in contact. The polymer material used in the present invention has a high coefficient of friction when placed on a formica, tile or wooden surface even if the surface is wet. The open spaces between disks allow liquids to be displaced from beneath each disk. When used as a floor or deck mat, said mat can prevent slip-and-fall accidents, and prevents objects from sliding around on a boat. Said non-skid mat also includes an annular tab connected to one corner elastomer disk of the mat by a strip of interconnecting elastomer material. This annular tab includes a central aperture for receiving a hook so that the mat may be hung for drying after use.

An object of this invention is to provide an inexpensive and effective non-skid mat for countertops to prevent the skidding and sliding of cutting boards or other kitchen utensils on smooth or wet surfaces while in use.

Another object of the invention is to provide a cushion to prevent the breakage and damage of dishes and cookware during contact with hard surfaces.

Still another object of this invention is to provide a non-skid mat that is easily cut by the user to reduce said mat to a size required by the user without losing the aesthetic appeal of said mat.

In accordance with these and other objects which will become apparent hereinafter, the instant invention will now be described with particular reference to the accompanying drawings.

### BRIEF DESCRIPTION OF THE DRAWINGS

FIG. 1 shows a top plan view of a multi-purpose, non-skid mat.

FIG. 2 shows a bottom plan view of the multi-purpose, non-skid mat.

FIG. 3 shows a perspective top view of the multi-purpose, non-skid mat.

FIG. 4 shows a side elevational of the multi-purpose, non-skid mat.

### DETAILED DESCRIPTION

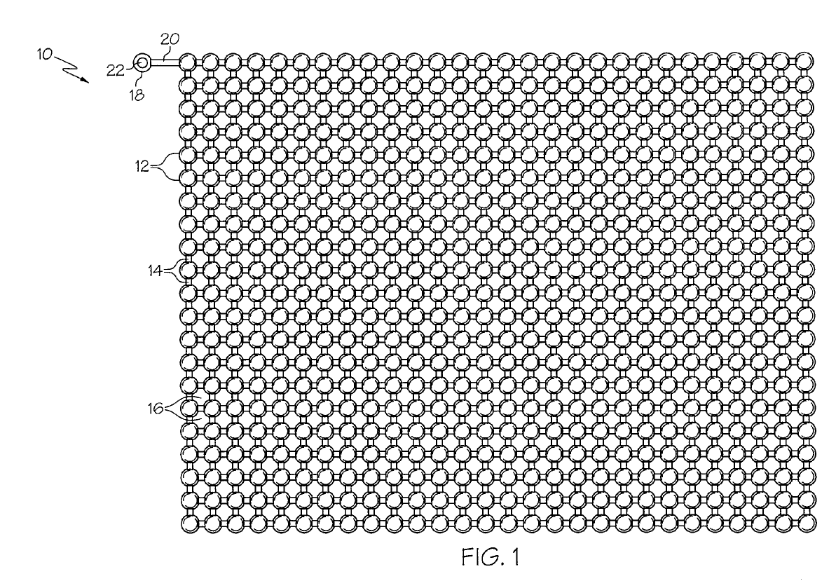

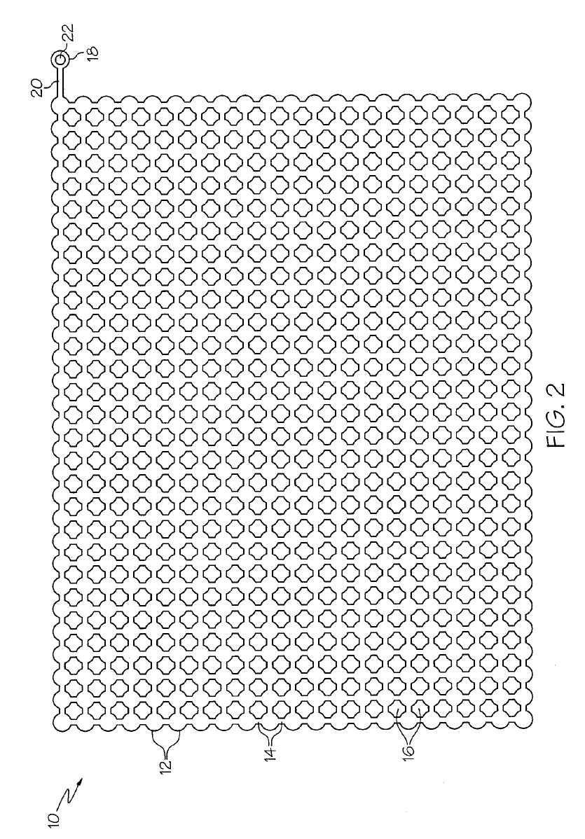

FIGS. 1-4 illustrate the invention, which is a multi-purpose, non-skid mat 10 comprising a single, flexible, flat body of elastomer material molded having a column and row array of elastomer disks 12 connected every 90 degrees by four elastomer strips 14. The mat body of elastomer material is formed into numerous parallel rows of thin cylindrical elastomer disks interconnected at approximately 90 degree angles by strips 14 of the same elastomer material. The elastomer disks 12 are flat on top and bottom and are thicker than the strips of elastomer interconnecting material, thereby creating an upper surface of said mat wherein the tops of said disks rise above the strips 14 of elastomer connecting material which remain flush with the bottom surface of the disks on said mat. Thus, when placed on a flat surface, such as a countertop, both the bottom surface of said elastomer disks and the bottom surface of the strips 14 of interconnecting elastomer material are coplanar and contact the planar surface of said countertop. As shown in FIG. 4, said elastomer disks 12 preferably are twice the thickness of the strips of elastomer material.

The mat is constructed preferably from an elastomer material that is flexible but has a large coefficient of friction relative to countertop materials such as formica, tile and wood. Said mat may also be constructed from other suitable non-skid materials that are flexible or rubber-like. The flexibility of the mat allows said mat to fit within and conform to the shape of the surface on which said mat is placed.

The mat can be cut or manually torn along a row and/or column of strips 14 to a size desired by the user so as to fit the user's requirements, such as for use as a cutting board mat, by cutting or manually tearing through the thin interconnecting elastomer strips, which are arranged linearly. The linear arrangement of the elastomer disks and interconnecting elastomer strips allows the mat to be cut and reduced to a smaller size as required by the user while preserving the aesthetic appeal of said mat. Preferably, the mat is 15 inches wide by 20 inches long to fit under standard-sized cutting boards, however, said mat can be constructed in any size required by consumers.

Each elastomer disk of the mat includes a planar top surface 12a having a smooth rounded edge 12b, a cylindrical wall 12c, and a planar bottom surface 12d. The cylindrical wall 12c is engaged by the strips 14 of elastomer material interconnected at evenly-spaced points oriented at 90 degrees from said cylindrical wall. Said elastomer disks 12 are arranged in parallel linear rows with linearly arranged strips 14 of elastomer material interconnecting adjacent disks at 90-degree angles.

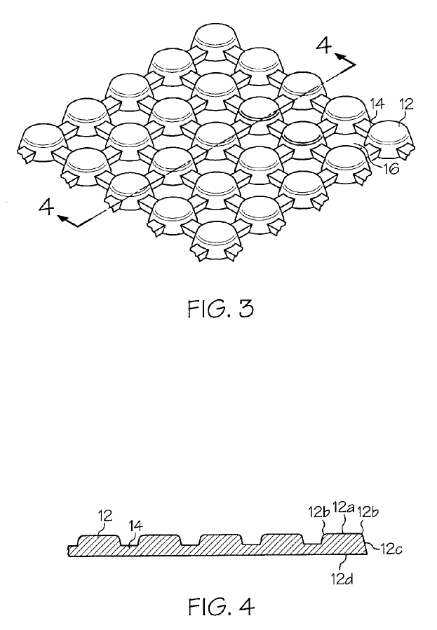

As illustrated in FIG. 3, the interconnected elastomer disks and adjoining strips of elastomer material together form a matrix of apertures 16 present between said disks and said strips of interconnected elastomer material. The mat body apertures 16 provide an area adjacent each disk 12 and strips 14 for excess countertop water to be received to aid in the non-skid action for slippery, wet countertops. This design, wherein the bottom surfaces of the disks and elastomer strips are coplanar, provides additional surface area for contacting the planar surface of a countertop, thereby preventing slipping or skidding of the mat on smooth or wet surfaces. The relatively large diameter of the top surface of the disks, which may range from 0.25-3.0 inches, provides sufficient surface area to increase the coefficient of friction so that a cutting board or mixing bowl placed upon the top surface of the mat does not move or skid. The top surface diameter of the disks is preferably 0.25 inches to provide optimal non-skid surface area while also providing a sufficient number of apertures to allow water to drain through the mat. In another embodiment, the mat may be constructed from disks having several different diameters interconnected at various angles by strips of interconnecting elastomer material.

The non-skid property of the construction material not only prevents damage and breakage of dishes and cookware, but also prevents accidents, in which a cutting board may slide while the user is using a knife to cut a food material or package on said cutting board.

The polymer material also acts like a cushion to protect glass and breakable dishware from hard surfaces such as a countertop.

The non-skid mat further includes a corner elastomer disk having an attached annular tab 18 connected to said corner disk by a strip of interconnecting elastomer material 20, said annular tab 18 including a central aperture 22 for receiving a hook so that the mat may be hung for drying after use.

The elastomer construction of the mat also provides protection to the surface over which said mat is placed, and exhibits low absorbency so that the mat does not retain water or bacteria that could produce a source of infection or disease. The mat can be washed in a dishwasher.

Said non-skid mat is useful for multiple purposes, including for placement under dishes, cookware, mixing bowls, countertop appliances, cutting boards, cutting blocks, pastry boards, and any other object for which the user requires stability to prevent skidding of the object while said object is being used by an individual. The mat can be used as a drying mat or as a shelf-liner for glassware, dishes, cookware, and any other objects with which the use of a drying mat or shelf-liner is desired. Said mat can also be used as a place mat on which dishes containing meals may be served to eliminate the sliding of dishes on a smooth table or countertop surface.

The non-skid mat can be used effectively as a protective cushion when placed between stacked non-stick pans or other dishes or cookware to prevent a bottom surface of a first pan from scratching the cooking surface of a second pan into which said first pan is stacked. Furthermore, the thick elastomer disks of said mat can be used to provide cushioning and protection to a countertop, thereby preventing physical contact with said countertop that otherwise may produce denting, scuffing, scratching, and other physical abrasions to said countertop. Another purpose of the non-skid mat is for use as a surface cover for placement on floors, decks, countertops, and other surfaces in buildings, cargo trucks and planes, boats, and other vessels to prevent skidding, slipping, and sliding of objects and persons aboard said boat or inside said building, truck, or plane.

The instant invention has been shown and described herein in what is considered to be the most practical and preferred embodiment. The applicant recognizes, however, that departures may be made therefrom within the scope of the invention and that obvious modifications will occur to a person skilled in the art.

What is claimed is:

1. A multi-purpose, non-skid mat comprising:
a single, flexible, thin body of elastomer material to prevent skidding, sliding, and slipping of objects or individuals on smooth, slippery, and wet surfaces, said body of elastomer material further comprising numerous parallel rows of elastomer disks interconnected at 90-degree angles by strips of elastomer material.

2. The non-skid mat of claim 1, wherein each elastomer disk includes:
a planar top surface having a smooth rounded edge;
a cylindrical wall to which said strips of elastomer material interconnect at evenly-spaced points oriented at 90 degrees from said cylindrical wall; and
a planar bottom surface having a straight sharp edge.

3. The non-skid mat of claim 1, wherein said elastomer disks are thicker than the strips of elastomer interconnecting material, so that the planar top surfaces of said elastomer disks are located higher than and raised above the strips of elastomer interconnecting material which remains flush with the bottom surfaces of the disks of said mat.

4. The non-skid mat of claim 1, wherein said elastomer disks are arranged in parallel linear rows.

5. The non-skid mat of claim 1, wherein said elastomer disks and said elastomer strips, which are interconnected throughout said mat with said elastomer strips protruding at 90-degree angles from evenly-spaced points on the outer cylindrical wall of each disk, form a matrix that includes one or more apertures present between said disks and said strips of interconnected elastomer material.

6. The non-skid mat of claim 1, wherein said mat is constructed preferably from elastomer material, but may also be constructed from other suitable non-skid materials that are flexible or rubber-like.

7. The non-skid mat of claim 1, wherein said mat can be cut or torn to a size and shape desired by the user so as to fit the user's requirements, such as for fitting under a cutting board or for use as a place mat, by cutting or manually tearing through the thin interconnecting elastomer strips, which are arranged linearly, thereby preserving the aesthetic appeal of the mat while allowing said mat to be reduced to a preferred size and shape.

8. The non-skid mat of claim 1, wherein said mat can be placed under dishes, cookware, mixing bowls, countertop appliances, cutting boards, cutting blocks, pastry boards, and any other object for which the user requires stability to prevent skidding of the object while said object is being used by an individual.

9. The non-skid mat of claim 1, wherein said mat can be used as a drying mat for glassware, dishes, cookware, and any other objects with which the use of a drying mat is desired.

10. The non-skid mat of claim 1, wherein said mat can be used as a shelf-liner for glassware, dishes, cookware, and any other objects with which the use of a shelf-liner is desired.

11. The non-skid mat of claim 1, wherein said mat can be used as a non-skid place mat on which dishes containing meals may be served to eliminate the sliding of dishes on a smooth table or countertop surface.

12. The non-skid mat of claim 1, wherein said mat can be used as a protective cushion when placed between stacked non-stick pans or other dishes or cookware to prevent a bottom surface of a first pan from scratching the cooking surface of a second pan into which said first pan is stacked.

13. The non-skid mat of claim 1, wherein said mat can be placed on floors, decks, countertops, and other surfaces in boats and other vessels to prevent skidding, slipping, and sliding of objects and persons aboard said boat.

14. The non-skid mat of claim 1, wherein the thick elastomer disks of said mat provide cushioning and protection to a countertop by preventing physical contact with said countertop that otherwise may produce denting, scuffing, scratching, and other physical abrasions to said countertop.

15. The non-skid mat of claim 1, wherein the numerous apertures passing through said mat allow water and other fluids to drain through the mat.

16. The non-skid mat of claim 1, wherein one purpose of said mat is to cushion the placement of dishes and cookware on a solid, hard planar surface so as to prevent damage and breakage of said dishes and cookware by contact with the hard surface.

17. The non-skid mat of claim 1, wherein said mat further comprises a corner disk having an attached annular tab connected to said corner disk by a strip of interconnecting elastomer material, said annular tab including a central aperture for receiving a hook so that the mat may be hung for drying after use.

18. A multi-purpose, non-skid mat, comprising:
means for preventing the skidding of objects and persons, and particularly, dishes, cookware, and cutting boards, while being used and for cushioning dishes and cookware placed on a solid, hard planar surface and stacked one into another to prevent damage or breakage of said dishes and cookware by contact with said hard surface and by contact with other dishes;
means for connecting said means for preventing and cushioning together to form a matrix surrounding numerous apertures that allow water to drain through said mat.

19. The non-skid mat of claim 18, wherein said means for preventing and cushioning comprises numerous parallel rows of elastomer disks.

20. The non-skid mat of claim 18, wherein said means for connecting comprises linearly arranged strips of elastomer material that interconnect with a cylindrical wall of each elastomer disk to which said strips of elastomer material are attached at evenly-spaced points oriented at 90 degrees from said cylindrical wall.

21. The non-skid mat of claim 18, wherein said mat further comprises a means for hanging said mat for drying after use.
